(19) United States
(12) Patent Application Publication
(10) Pub. No.: US 2014/0379300 A1
(43) Pub. Date: Dec. 25, 2014

(54) PUMP EFFICIENCY DETERMINING SYSTEM AND RELATED METHOD FOR DETERMINING PUMP EFFICIENCY

(71) Applicant: GHD Pty Ltd, Melbourne, Victoria (AU)

(72) Inventors: Thomas W. Devine, Cazenovia, NY (US); Alissa J. Diminich, Cazenovia, NY (US); Andrew James Weiss, Fayetteville, NY (US)

(73) Assignee: GHD PTY LTD, Melbourne, Victoria (AU)

(21) Appl. No.: 14/376,326

(22) PCT Filed: Feb. 1, 2013
(86) PCT No.: PCT/AU2013/000086

§ 371 Date: Aug. 1, 2014

Related U.S. Application Data
(63) Continuation of application No. 13/364,533, filed on Feb. 2, 2012.

(51) Int. Cl. G01M 99/00; F04D 15/00; F04B 51/00

(52) U.S. Cl. CPC G01M 99/008; F04B 51/00; F04D 15/0088
USPC 702/182

(57) ABSTRACT

A system for measuring real time efficiency/performance of at least one pump in a plant or other facility includes a plurality of monitoring devices disposed in relation to said at least one pump to measure power usage, pump speed and flow characteristics of the at least one pump. A processing system is configured to receive input signals from the sensors in which the efficiency of the at least one pump can be calculated based on the sensor inputs in real-time. The processing system can also compare the calculated pump efficiency values with a user defined set point or threshold or compare to the expected pump performance.

### TECHNICAL FIELD

The subject matter disclosed herein generally relates to pumping systems and more specifically to a system and related method for providing in-situ determinations of the performance of at least one pump, for example, a reciprocating or centrifugal pump, which is provided for use in a pumping facility. In-situ performance determinations can be compared to expected characteristics of the pump, thereby enabling system operators to be proactively alerted as to declining performance of at least one pump.

### BACKGROUND

Pumping systems that are used in a range of industries, including the water, power and oil sectors, may not operate at maximum efficiency due to damaged and worn impellers, pitted volutes, bad motor windings, poor couplings and poorly commissioned pump controls, among other factors.

In most of the foregoing situations, these operating issues cannot be visibly detected and in fact may not be discovered until after the pump has already been taken out of service for scheduled maintenance, or until the problem has exacerbated to the point in which a severe or catastrophic failure has occurred.

Pumps represent a significant portion of the pumping facility energy and life cycle costs and are often critical components of a process (manufacturing or otherwise). To that end, the facility's reliability is optimal when the pumps are maintained on the basis of continuous or periodic condition monitoring. Studies have shown that 20% or more of the energy consumed by pump systems could be saved through equipment or control changes and that performance-based maintenance costs are significantly lower than calendar-based costs.

For the above-noted reasons, at a minimum, there is a palpable need to provide a real time technique for determining whether individual pumps within a facility pumping system are operating efficiently.

Attempts have previously been, made to monitor pump efficiency using the so-called “thermodynamic method”, which measures heat transfer. Efficiency of pumps using this system, however, such as reciprocating and centrifugal pumps, is impractical to calculate where pumps are operating at variable speed and existing market products using this method are not configured for variable speed operation. In addition, thermodynamic based systems are unable to estimate heat transfer in non-fluid mediums such as bearings and pump casings. Therefore, the larger the pump, the more likely this type of system is going to be inaccurate.

### SUMMARY OF THE DISCLOSURE

Therefore and according to one aspect, there is provided a processing system for determining operating efficiency of at least one pump in a pumping facility, said system comprising:
at least one controller that collects characteristics of said at least one pump and having processing logic that calculates performance of said at least one pump based on said collected characteristics, said calculated performance being compared to at least one stored threshold.

In one version, the at least one threshold is a predetermined efficiency value. According to another version, the calculated real-time performance of the at least one pump is compared to stored performance curves under the same conditions.

If the compared performance is less than the desired threshold, then the operator is alerted and corrective action can be implemented. According to one version, if the performance falls below another established threshold, the at least one pump can be taken off line and/or a maintenance alert is automatically generated.

According to one version, the above processing system is incorporated into the pumping facility's existing Supervisory Control and Data Acquisition (SCADA) system.

In another version, the real-time performance characteristic values upon collection are interpreted in order to ascertain whether the signals received are valid prior to calculating performance and prior to displaying or otherwise indicating any calculated values to the operator.

In one version, actual pump efficiency is calculated by the processing system using the following relation,

$${Pump}_{eff ( a )} = \frac{Q \times H \times SpGr}{c \times {kW}_{( a )} \times {Motor}_{eff}}$$

in which Q represents the flow rate of an incompressible fluid through said pump, H represents head as the measured pressure difference between the discharge and suction sides of said at least one pump, SpGr is the specific gravity of the incompressible fluid pumped, kW₍ₐ₎ represents the measured power drawn by the at least one pump, Motor_{eff} represents published motor efficiency and c represents a unit conversion factor.

According to another aspect, there is provided a system for measuring efficiency of at least one pump in a pumping facility, said system comprising:
a plurality of sensors disposed in relation to said at least one pump to measure characteristics of said at least one pump; and
a processing system programmed to receive inputs from said sensors and to calculate actual performance of said at least one pump based on said measured characteristics using the hydraulic method and in which actual performance is compared to at least one stored threshold value relating to said at least one pump.

In one exemplary version, various inputs are collected from the sensors that continually monitor power usage, instantaneous pump speed and flow characteristics relating to the at least one pump. Each of the above devices are operatively connected so as to measure these pump-related parameters in real time or periodically, the inputs from each device being collected and transmitted to the processing system. In one version, the said processing system includes a programmable logic controller (PLC) that is programmed to receive each of the separate inputs from the above-noted sensors and to transmit the signals to the facility's existing SCADA system. The collected data is then analyzed and processed to determine the at least one pump's efficiency. According to one exemplary version of the system, the pump's operating point can be compared against the pump manufacturer's published pump curve. At predetermined intervals, the pump efficiency can further be trended based on historical data that has been previously collected, stored and processed.

In one exemplary version, the collected inputs are first interpreted to verify that the signals received from each of the devices are valid and that all inputs have been received prior to calculating performance and prior to displaying or otherwise indicating any calculated values or claims to the user or operator of the apparatus.

Hierarchically and if the pump's efficiency drops below a predetermined percentage according to one version, a warning alarm and maintenance work order can be automatically generated as well as a cost estimate relating to the inefficiency. Alternatively, an alert message can be generated by the SCADA system in lieu of a work order. If efficiency falls below a second predetermined percentage, the pump is automatically taken out of service and a back-up or lag pump can be brought into use.

According to another aspect, there is described a method for determining efficiency of at least one pump configured in a pumping facility, said method comprising the steps of
measuring various operating parameters of said at least one pump;
transmitting the measured operating parameters to a processing system; and
calculating the actual efficiency of said at least one pump using the measured operating parameters.

In existing systems there may be a plurality of devices disposed in relation to said at least one pump that measure specific characteristics of said at least one pump. In these existing systems, it may be necessary to replace partially or in their entirety the plurality of existing devices with new devices with the capacity to measure and transmit observations of specific characteristics for the intent of transmission, collection and computation.

According to an exemplary embodiment, the actual pump efficiency can be determined by the processing system using the relation,

$${Pump}_{eff ( a )} = \frac{Q \times H \times SpGr}{c \times {kW}_{( a )} \times {Motor}_{eff}}$$

in which Q represents flow rate of an incompressible fluid through said pump, H represents the head as the measured pressure differential between the discharge and suction sides of said at least one pump, SpGr represents the specific gravity of the incompressible fluid pumped, kW₍ₐ₎ represents the measured power drawn by said at least one pump, Motor_{eff} represents a published motor efficiency, and c represents a unit conversion factor stored by said system.

In one version, expected pump performance is stored by the processing system and then is used in order to compare to the calculated actual efficiency.

One advantage obtained by the herein described system and method is that early and proactive determinations can be made to at least one pump disposed in a manufacturing or other processing facility or pumping station in advance of failure and thereby improving the chances for optimal performance.

The present system creates a seamless and automatic method of capturing and then analyzing the data required to identify a pump's operating efficiency within a facility by integrating existing and non-proprietary technologies with widely adopted systems (hardware and software) uniquely in order to identify pumps that operate below published performance levels.

Another advantage is that the present system can be easily retrofitted into existing facilities and pumping systems enabling a full range of pump variables to be captured in real time so as to calculate and analyze pump efficiency within a system using the hydraulic method wherein a full system of pumps of varying brands and models already in service can be suitably analyzed.

Another advantage realized by the herein described system is that determinations of decline in pump(s) performance can permit adjustments or replacements in a proactive manner, thereby maintaining overall system efficiency and performance in advance of potentially catastrophic events, as well as related improvements in cost and labor in operating these facilities.

In another broad form the present invention seeks to provide a method for determining efficiency of at least one pump configured in a pumping facility, said method including the steps of:
measuring various operating parameters of said at least one pump;
transmitting the measured operating parameters to a processing system; and
calculating the actual efficiency of said at least one pump based on the measured operating parameters.

Typically the method further includes the step of comparing the calculated efficiency of said pump to an expected efficiency of said pump under the same operating conditions and providing an alert if the compared actual efficiency deviates from the expected efficiency by a predetermined amount.

Typically the method includes the step of disposing a plurality of sensors for measuring the power usage and flow characteristics of said at least one pump, wherein said sensors include means for transmitting collected signals to said processing system.

Typically the method includes the step of disposing a plurality of sensors for measuring the pump speed of said at least one pump, wherein said sensors includes means for transmitting collected signals to said processing system.

Typically the plurality of sensors are configured to periodically or continually measure and transmit said operating parameters.

Typically the processing system includes at least one controller that receives the readings from said monitoring devices, said method including the step of transmitting said values to said at least one controller for calculating said efficiency.

Typically the processing system includes at least one controller that receives the readings from said monitoring devices, said method including the step of transmitting said values from said at least one controller to the facility operating system for calculating said efficiency.

Typically the method includes the step of displaying at least one measured or calculated value related to said at least one pump.

Typically the method includes the additional step of interpreting the measured readings of said sensors and the calculated values prior to said displaying step.

Typically the interpreting step further includes the step of determining whether potential errors exist in at least one of the collected readings of said sensors and the calculated values.

Typically the method includes the additional step of indicating the potential cause of said potential errors to a user or operator.

Typically the pumping system is a multi-pump system, said method including the to additional steps of determining a change in efficiency in at least one of the pumps and indicating a revised sequence for use of said pumps based on said change.

Typically the method includes the additional steps of determining the actual pump efficiency, identifying the expected pump efficiency and calculating the differences between the actual and expected pump efficiencies.

Typically the actual pump efficiency is determined using the relation

$${Pump}_{eff ( a )} = \frac{Q \times H \times SpGr}{c \times {kW}_{( a )} \times {Motor}_{eff}}$$

in which Q represents flow rate, H (head) represents the pressure differential between the discharge and suction sides of said at least one pump, SpGr represents the specific gravity of the incompressible fluid flowing through said pump, kW₍ₐ₎ represents the power used by the pump, Motor_{eff} represents a published value of motor efficiency and c represents a unit conversion factor stored by said system

Typically the method includes the steps of storing application specific and manufacturer specific data in the memory of the controller for said calculating step in conjunction with the collected pump-related data.

In another broad form the present invention seeks to provide a system for measuring efficiency of said at least one pump in a pumping facility, said system including:
a plurality of sensors disposed in relation to said at least one pump to measure characteristics of said at least one pump; and
at least one controller configured to periodically receive inputs from said sensors and to calculate actual performance of said at least one pump based on said measured characteristics using the hydraulic, method and in which the actual performance is compared to at least one stored threshold value relating to said at least one pump.

Typically the system includes means for displaying at least one measured or calculated value relating to said at least one pump.

Typically the inputs from said sensors and the resulting calculated values are validated prior to displaying same.

Typically an alert is triggered if the performance of the at least one pump deviates from said expected performance by a predetermined amount.

Typically the controller is configured to store published performance curves of said at least one pump.

Typically the possible cause of deviation from the expected performance is presented to the user.

Typically the controller is wirelessly connected to said sensors, each of said sensors transmitting pump-related data to said controller over the wireless connection.

Typically the plurality of sensors include a flow measuring device, a power usage measuring device and at least one pressure measuring device.

Typically the plurality of sensors include a pump speed measuring device.

In a further broad form the present invention seeks to provide a processing system for determining operating efficiency of at least one pump in a pumping facility, said system including:
at least one controller that collects characteristics of said at least one pump and having processing logic that calculates performance of said at least one pump based on said collected characteristics, said calculated performance being compared to at least one stored threshold.

Typically the measured characteristics include flow rate, power consumption, suction and discharge pressures and pump motor speed.

Typically the real-time efficiency of said at least one pump is determined by the relation

$${Pump}_{eff ( a )} = \frac{Q \times H \times SpGr}{c \times {kW}_{( a )} \times {Motor}_{eff}}$$

in which Q represents flow rate, H (head) represents the pressure differential between the discharge and suction sides of said at least one pump, SpGr represents the specific gravity of the incompressible fluid flowing through said pump, kW₍ₐ₎ represents the power used by the pump, Motor_{eff} represents a published value of motor efficiency and c represents a unit conversion factor stored by said processing system.

Typically characteristics are collected at periodic intervals, said at least one controller including a programmable logic controller that is connected to the pumping facility's Supervisory Control and Data Acquisition (SCADA) system.

Typically the processing system includes a plurality of sensors for measuring said pump-related characteristics in real time, said sensors having means for transmitting collected values to said at least one controller.

In another broad form the present invention seeks to provide a method for determining an efficiency indicator indicative of a pump operating efficiency of at least one pump, the method including, in a electronic processing device:
a) determining a head of the at least one pump;
b) determining a flow rate of the at least one pump;
c) determining a power consumption of the at least one pump; and,
d) determining an efficiency indicator indicative of the pump operating efficiency of the at least one pump using the head, the flow rate, and the power consumption.

Typically the method includes, in the electronic processing device:
a) determining an inlet pressure value of the at least one pump;
b) determining an outlet pressure value of the at least one pump; and,
c) determining the head using the inlet pressure value and the outlet pressure value.

Typically the method includes, in the electronic processing device:
a) determining a specific gravity of a fluid pumped by the at least one pump; and,
b) determining the efficiency indicator using the specific gravity.

Typically the method includes, in the electronic processing device:
a) determining a pump motor efficiency of the at least one pump; and,
b) determining the efficiency indicator using the pump motor efficiency.

In another broad form the present invention seeks to provide an apparatus for determining an efficiency indicator indicative of a pump operating efficiency of at least one pump, the apparatus including a electronic processing device for:
a) determining a head of the at least one pump;
b) determining a flow rate of the at least one pump;
c) determining a power consumption of the at least one pump; and,
d) determining an efficiency indictor indicative of the pump operating efficiency of the at least one pump using the head, the flow rate, and the power consumption.

Typically the electronic processing device is for:
a) determining an inlet pressure value of the at least one pump;
b) determining an outlet pressure value of the at least one pump; and,
c) determining the head using the inlet pressure value and the outlet pressure value.

Typically, the apparatus includes at least one sensor for sensing characteristics of the at least one pump, wherein the characteristics include at least one of:
a) an inlet pressure;
b) an outlet pressure;
c) flow; and,
d) power.

Typically the electronic processing device is adapted to monitor signals from the at least one sensor and, generate at least in part using the signals, any one or more of:
a) the inlet pressure value of the at least one pump;
b) the outlet pressure value of the at least one pump;
c) the head of the at least one pump;
d) the flow rate of the at least one pump; and,
e) the power consumption of the at least one pump.

These and other features and advantages will be readily apparent from the following Detailed Description, which should be read in conjunction with the accompanying drawings.

### BRIEF DESCRIPTION OF THE DRAWINGS

FIG. 1 illustrates a schematic diagram of a pumping system in accordance with the prior art;

FIG. 2 depicts a schematic diagram of an in-situ pump performance measuring system in accordance with an exemplary embodiment;

FIG. 3 is a diagrammatic flow diagram of the in-situ pump performance measuring system of FIG. 2 and various processing logic operations used by the processing system to determine actual pump efficiency in accordance with one version;

FIG. 4 is a flow chart of an example of a method for determining an efficiency indicator indicative of a pump operating efficiency of one or more pumps; and,

FIG. 5 is a schematic diagram of an example of a processing system for determining an efficiency indicator indicative of a pump operating efficiency of one or more pumps.

### DETAILED DESCRIPTION

The following description relates to an exemplary embodiment of a system and related method used to determine pump efficiency/performance in real time. A single generic pumping system/application is described for purposes of this exemplary embodiment, but it will be readily understood that this system and related method is applicable to literally any form of pumping system in which various characteristics of a single or multiple-pump systems pumping incompressible fluid can be measured in situ and in which overall efficiencies of at least one pump of the facility can be determined in real time or periodically. However, it will be readily apparent that the herein related system and method is not limited to specific applications or fields of use. To that end, the herein described system minimally realizes applications such as potable water and waste water treatment plants within the water sector, nuclear gas and electricity plants within the power sector and oil drilling and refinery sectors.

In the course of discussion, various terms are used in order to provide a convenient frame of reference in regard to the accompanying drawings. These terms, however, should not be interpreted narrowly with regard to the novel aspects described herein, except where so specifically indicated. In addition, the accompanying drawings provided in this application are not intended to represent a scaled depiction of the present system or method, with the intended emphasis therein focusing on connectivities of related components and use of the data that is obtained therefrom.

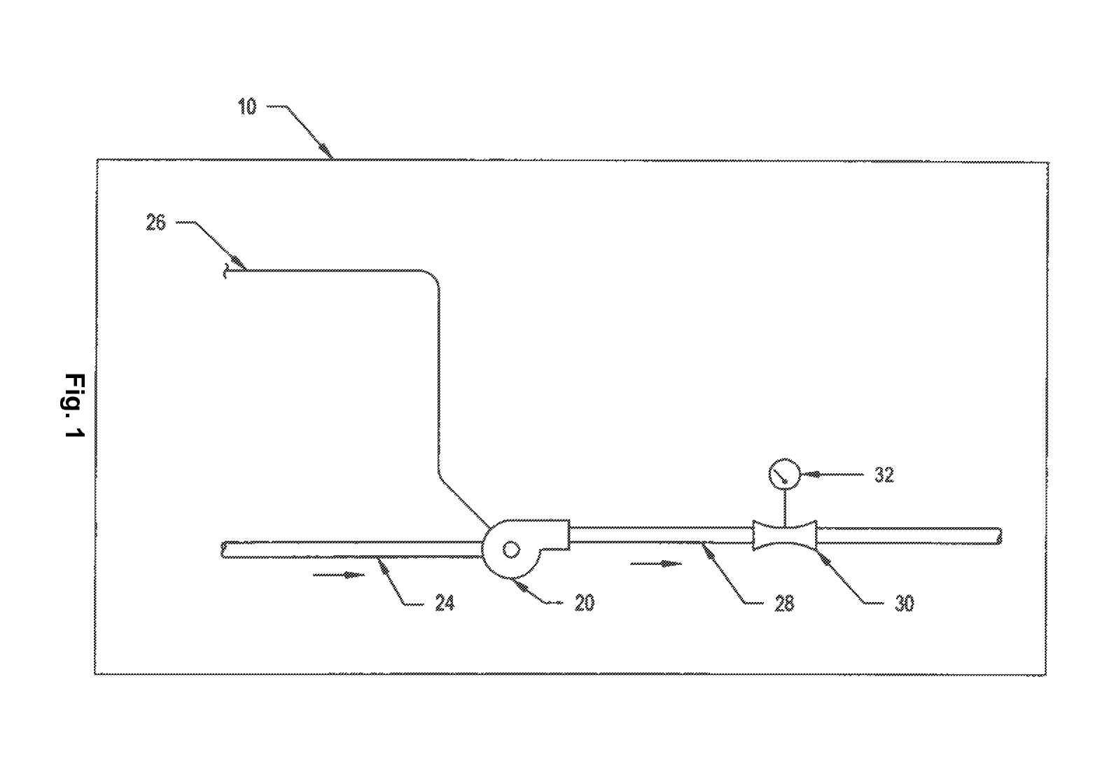

Referring to FIG. 1, there is provided a prior art representation of a pumping system, partially shown and labeled herein as 10, shown for purposes of background. The pumping system 10 includes a pump 20, such as a reciprocating or centrifugal pump, containing a pump motor (not shown) that is hydraulically connected via respective suction and discharge lines 24, 28. The pump motor is powered by an AC power source (not shown) connected through power line 26. In this system, a flow rate measuring device 30 is provided along the discharge line 28, in which the flow rate is determined and readable to a user on an attached display 32.

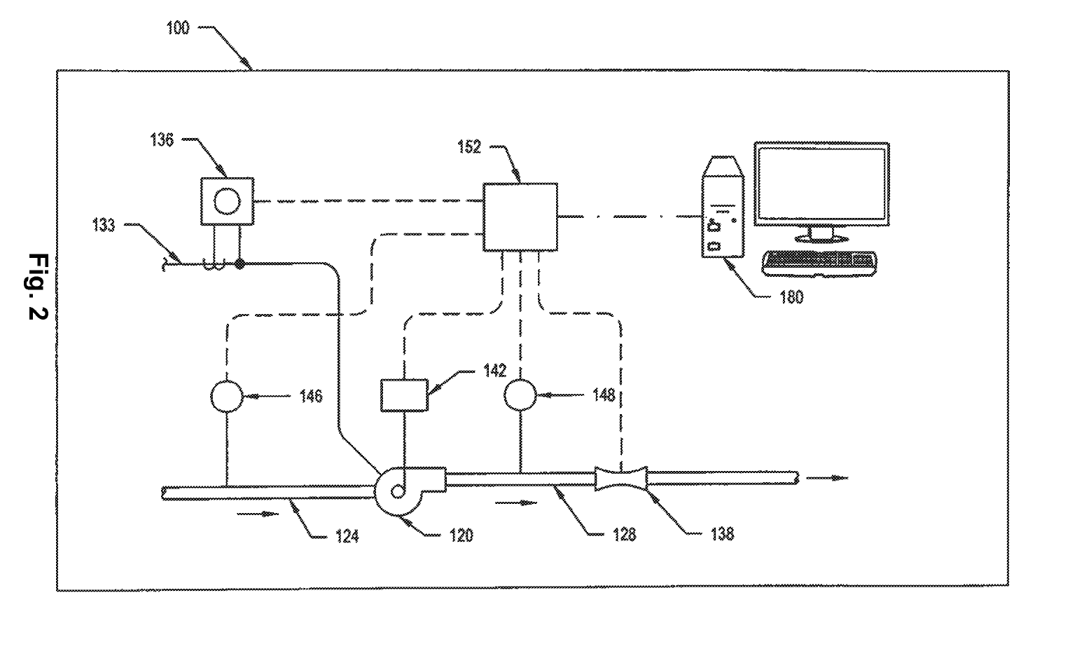

Referring to FIG. 2, there is set forth a schematic diagram of a pump as configured for operational use in a facility or plant, such as a pumping or processing station, and in which the pump is configured according to an exemplary version of the present pump efficiency/performance system. The facility, partially shown herein is identified throughout by reference numeral 100, and includes a pump 120, which is hydraulically linked in the facility by respective suction and discharge lines 124, 128. The pump 120 is a reciprocating type pump, or a centrifugal pump, defined by a housing that retains a plurality of components including a pump motor (not shown in this schematic view). The pump motor can be a fixed speed motor or a variable speed motor for purposes of this discussion. In brief, an incompressible fluid with a predetermined specific gravity, such as water, hydraulic fluid, or the like is supplied by the suction line 124 to the pump 120 and then guided through chambers disposed within the pump housing/motor, wherein the fluid is subsequently dispensed under pressure through the discharge line 128.

As opposed to current pumping systems and according to the herein described system, a plurality of sensors are operatively provided in order to continually monitor and measure specific characteristics of the pump 120. According to this exemplary embodiment, a total of five (5) sensors or measuring devices are disposed within the active circuit of the pump 120, these devices including a power meter 136 that is disposed and connected in relation to the electrical connection line 133 of the pump 120, a flow measuring device 138 disposed in the discharge line 128, a pump motor speed measuring device 142 connected to the output of the pump motor, and a pair of pressure transducers 146, 148 used to monitor the suction and discharge pressures, respectively, relative to the pump 120, the latter devices being disposed in lieu of conventional pressure gauges typically used to provide visual indications of same. In the instance that the pump 120 employs a fixed speed motor, the pump power speed device 142 could be optional.

As to the devices utilized for purposes of measuring the characteristics, the choice of device can be based on the type of pump motor. For example and if the pump motor is belt driven, the pump speed measuring device 142 could be a tachometer, a variable frequency drive (VFD) or other device capable of measuring instantaneous pump motor speed, such as a drive ratio device and transmitting an electronic signal. If the motor is shaft driven or close coupled, then a tachometer or VFD can also be used. As to the pressure measuring devices 146, 148, various devices can be used, for example, separate pressure sensors, level sensors, or a single differential pressure sensor. Alternately, manometers or other similar devices capable of providing an electronic signal output can be utilized.

Each of the above noted measuring devices 136, 138, 142, 146, 148 according to this embodiment are further connected to a processing system that includes a controller 152, such as a Programmable Logic Controller (PLC), for example those made by Allen Bradley. The monitoring devices 136, 138, 142, 146, 148 can be hard-wired to the controller 152 or can alternatively be linked by means of a suitable wireless connection, such as using IEEE 802.11 Standard, Bluetooth, Zigbee or other suitable linkage via an access point (not shown) provided in the facility 100. The controller 152 is configured with sufficient volatile and non-volatile memory for the storage of collected data, as well as a contained microprocessor (not shown). The controller 152 is programmed to receive input from each of the devices 136, 138, 142, 146 and 148 on a periodic basis for transmission to the facility's Supervisory Control and Data Acquisition (SCADA) system 180, the latter having a microprocessor programmed with sufficient logic in accordance with the present system in order to calculate pump efficiency/performance, as described herein. Though only one pump 120 is shown for purposes of this description, it will be readily apparent that a plurality of pumps can be similarly equipped as described herein for purposes of measuring each of the relevant characteristics and communicating these measured characteristics to a common or plurality of controllers.

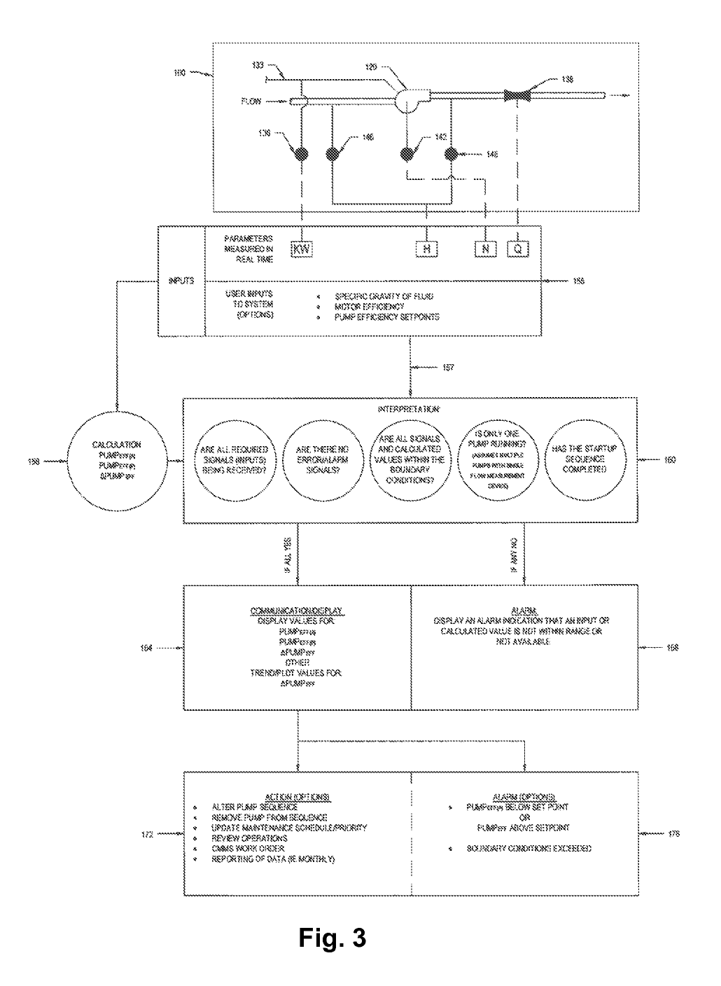

Referring to the flow diagram, FIG. 3, and according to this exemplary embodiment, the pump-related signals that are generated by the devices 136, 138, 142, 146 and 148 are transmitted or otherwise collected on a periodic or continual basis (e.g., 15-30 minutes) by the controller 152 of the processing system for calculation of the operating performance (efficiency) of the pump 120.

The pump-related parameters that are continually monitored according to this exemplary system version are Q (flow) as measured by the flow measuring device 138, H (Head or ΔP) as measured by the pressure measuring devices 146, 148, pump motor speed (N) as measured by the pump speed measuring device 142 and power consumption (kW) as measured by the power meter 136. According to this version, information is continually or periodically collected by each of the disposed devices and transmitted on a periodic basis or on demand by the controller 152 or alternatively by the SCADA system 180. As described herein, the foregoing measured data is used in conjunction with manufacturer-specific data and application-specific data that is stored by the SCADA system 180 to permit determinations of pump efficiency/performance and comparisons to expected pump performance.

For purposes of this embodiment, the manufacturer-specific data relating to the pump 120 that is entered manually into the microprocessor of the SCADA system 180 includes the published pump efficiency (Pump_{eff(p)}, the latter of which is measured as a function of pump speed, pump performance curves (head vs. flow, entered as tabular data or a polynomial function), and the pump motor efficiency (Motor_{eff}), for specific applications. As noted, application-specific data is also manually entered into the non-volatile memory of the SCADA system 180, including the specific gravity of the pumped fluid (SpGr). Optionally, other application-specific data, such as the cost of power ($/kWh) and various system curve data, can also be stored for use to be utilized in conjunction with the measured pump-related parameter data obtained from the monitoring devices 136, 138, 142, 146, 148, depending on the application.

The following presents an example of one set of relations used for determining pump efficiency/performance and the derivation thereof. This example indicates the relations using US or metric units. It will be readily apparent that other mathematical models and units could be utilized in a similar fashion. Specific parameters are identified first herein, each listed in the following Table I, as follows:

TABLE I

| | | | | Units | |
|---|---|---|---|---|---|
| Parameter Symbol | Parameter Name | Value Determination | Function of | US | Metric |
| $/kWh | Cost of Power | Provided | — | $ per kilowatt hour | $ per kilowatt hour |
| | | | | ($/kWh) | ($/kWh) |
| BHP | Brake Horsepower | Calculated | kW, Motor_{eff} | Horsepower (HP) | Horsepower (HP) |
| H | Head | Measured/Calculated | ΔP | Feet | Meters |
| Hyd_{HP} | Hydraulic Horsepower | Calculated | Q, H, SpGr | Horsepower (HP) | Horsepower (HP) |
| kW₍ₐ₎ | Kilowatts Actual | Measured/Variable | — | kilowatt (kW) | kilowatt (kW) |
| kW₍ₚ₎ | Kilowatts Published | Provided/Calculated | Q, H, kW, | kilowatt (kW) | kilowatt (kW) |
| | | | Motor_{eff} Pump_{eff(p)} | | |
| Motor_{eff} | Motor Efficiency | User Input | — | Percent (%) | Percent (%) |
| N | Pump Speed | Measured | — | Revolutions per | Revolutions per |
| | | | | minute (rpm) | minute (rpm) |
| ΔP | Differential Pressure | Measured/Calculated | — | | |
| Pump_{eff(a)} | Pump Efficiency Actual | Calculated | Q, H, kW, Motor_{eff} | Percent (%) | Percent (%) |
| Pump_{eff(p)} | Pump Efficiency Published | Provided/Calculated | N | Percent (%) | Percent (%) |
| Q | Flow rate | Measured/Variable | — | Gallons per | Liters per second |
| | | | | minute (gpm) | (lps) |
| SpGr | Specific Gravity | User Input | — | unitless | unitless |

In terms of this exemplary embodiment, the relevant equations for purposes of determining pump efficiency/performance employing the above listed parameters are derived as follows:

### US Units

Head can either be a measured or calculated value, depending on the devices used in a given system. When pressure measuring devices are used to measure suction and discharge pressures, the differences in those values is used to calculate Head (H) by

H=k×ΔP (1)
where k is a constant used to convert ΔP into units of height of water, e.g., feet.

Hydraulic horsepower is calculated by the following relation, namely

$${Hyd}_{HP} = \frac{Q \times H \times SpGr}{3.960} \qquad ( 2 )$$

in which H is Head, as detailed above. Pump Efficiency is determined as

$${Pump}_{eff} = \frac{{Hyd}_{HP}}{BHP} \qquad ( 3 )$$

Rearranging,

$${Pump}_{eff} = \frac{Q \times H \times SpGr}{3.960 \times BHP} \qquad ( 4 )$$

Power draw is determined as

$$kW = \frac{BHP}{{Motor}_{eff}} \times 0.75 \qquad ( 5 )$$

Rearranging the foregoing equation,

$$BHP = \frac{kW \times {Motor}_{eff}}{0.75} \qquad ( 6 )$$

Therefore, including equation (6) in place of BHP shown in equation (4),

$${Pump}_{eff} = \frac{Q \times H \times SpGr}{5.280 \times kW \times {Motor}_{eff}} \qquad ( 7 )$$

Using the above relationships, actual pump efficiency can therefore be determined using measured values for Q, H and kW:

$${Pump}_{eff ( a )} = \frac{Q \times H \times SpGr}{5 , 280 \times {kW}_{( a )} \times {Motor}_{eff}} \qquad ( 8 )$$

Pump affinity laws are defined as

$$\begin{matrix}\frac{{BHP}_{1}}{{BHP}_{2}} = {( \frac{Q 1}{Q 2} )}^{3} = {( \frac{N 1}{N 2} )}^{3} & ( 9 ) \\ \frac{H 1}{H 2} = {( \frac{N 1}{N 2} )}^{2} & ( 10 )\end{matrix}$$

Using the above relationships, published pump efficiency can therefore be determined by referencing published pump performance curves that define the relationship between Pump_{eff(p)} and N at various flow and head conditions.

In addition, expected pump motor draw can also be determined using measured values of Q and H and published value of Pump_{eff(p)} at the actual pump speed, N:

$$kW ( p ) = \frac{Q \times H \times SpGr}{5 , 280 \times {Pump}_{eff ( p )} \times {Motor}_{eff}} \qquad ( 11 )$$

In the above formulas (2) through (11) the values 3960, 0.75, and 5280 represent unit conversion factors c₁, c₂, and c₃, respectively.

### Metric Units

Head (H) can either be a measured or calculated value, depending on the devices used in a given system. When pressure measuring devices are used to measure suction and discharge pressures, the differences in those values is used to calculate Head by

H=k×ΔP (12)
where k is a constant used to convert ΔP into units of height of water, e.g., meters.

Hydraulic horsepower is calculated by the following relation, namely

$${Hyd}_{HP} = \frac{Q \times H \times SpGr}{76.1} \qquad ( 13 )$$

in which H is Head, as detailed above. Pump Efficiency is determined as

$${Pump}_{eff} = \frac{{Hyd}_{HP}}{BHP} \qquad ( 14 )$$

Rearranging,

$${Pump}_{eff} = \frac{Q \times H \times SpGr}{76.1 \times BHP} \qquad ( 15 )$$

Power draw is determined as shown above in equation (5) and repeated below,

$$kW = \frac{BHP}{{Motor}_{eff}} \times 0.75 \qquad ( 5 )$$

Rearranging the foregoing equation, as shown above in equation (6) and repeated below,

$$BHP = \frac{kW \times {Motor}_{eff}}{0.75} \qquad ( 6 )$$

Therefore, including equation (6) in place of BHP shown in equation (15),

$${Pump}_{eff} = \frac{Q \times H \times SpGr}{101.5 \times kW \times {Motor}_{eff}} \qquad ( 16 )$$

Using the above relationships, actual pump efficiency can therefore be determined using measured values for Q, H and kW₍ₐ₎:

$${Pump}_{eff ( a )} = \frac{Q \times H \times SpGr}{101.5 \times {kW}_{( a )} \times {Motor}_{eff}} \qquad ( 17 )$$

Pump affinity laws are defined above in equations (9) and (10) and repeated below as,

$$\begin{matrix}\frac{{BHP}_{1}}{{BHP}_{2}} = {( \frac{Q 1}{Q 2} )}^{3} = {( \frac{N 1}{N 2} )}^{3} & ( 9 ) \\ \frac{H 1}{H 2} = {( \frac{N 1}{N 2} )}^{2} & ( 10 )\end{matrix}$$

Using the above relationships, published pump efficiency can therefore be determined by referencing published pump performance curves that define the relationship between Pump_{eff(p)} and N at various flow and head conditions.

In addition, expected pump motor draw can also be determined using measured values of Q and H and published value of Pump_{eff(p)} at the actual pump speed, N:

$${kW}_{( p )} = \frac{Q \times H \times SpGr}{101.5 \times {Pump}_{eff ( p )} \times {Motor}_{eff}} \qquad ( 18 )$$

In the above formulas (12) through (18) the values 76.1, 0.75, and 101.5 represent respective unit conversion factors c4, c5, and c6.

According to the present embodiment, the SCADA system 180 is configured to calculate and display or otherwise provide an indication of the results of equations (8) and (11) or equations (17) and (18) on a periodic basis (e.g., every 15-30 minutes). It will be readily apparent that the period in which results are displayed can be easily modified depending on the application. Moreover, the monitoring devices do not necessarily require the ability to continually monitor each of the pump-related parameters, provided that measured values can be collected for transmission to the controller 152 on either a periodic basis or alternatively on demand. More specifically and in the current system, the input signal results, shown collectively as 155 in FIG. 3 are transmitted from the controller 152 to the SCADA system 180. This transmission can take place over a wired connection, or wirelessly, wherein the data can be transmitted every 15-30 minutes or other predetermined timeframe.

Prior to display, and possibly concurrently to any calculations, however and according to this exemplary embodiment, the microprocessor of the SCADA system 180 is additionally programmed to first interpret or otherwise examine the validity of the various signals that have been collected by the various sensors 136, 138, 142, 146, 148 and the values that have been calculated using the mathematical relationships noted in the foregoing discussion, specifically actual pump efficiency, published pump efficiency and the resulting difference between the actual and published efficiency values. As a result, this interpretative element of the herein described system provides a filter prior to transmitting and displaying (or otherwise indicating) the resulting efficiencies/performance. The purpose of this component of the herein described system is to identify an error in either the signal or calculations and to either display or otherwise notify the operator.

Interpretative issues for consideration according to this embodiment are noted at step 160, FIG. 3, and include the following: i) whether all input signals from each of the measuring devices 136, 138, 142, 146, 148 have been received before making the required, performance calculations (i.e., has there been a loss in signal or an obvious error in the signal received), ii) whether all signals are within the anticipated boundary conditions for each collected value (reading), iii) comparative history discrepancies between signals including any relative rates of change of signals, iv) verification that no alarm/error signals, and v) that the start-up sequence of the pump has been completed. Additionally and in the instance of multiple pump systems being used in the facility 100, verification can also be made that only one pump is operating if used with a single or common flow measurement device 138.

As noted, the above-noted interpretation component of the herein described system acts as a filter prior to transmitting the calculated values to the SCADA system 180 for, display or otherwise communicating useful data to the operator/user. In addition to the pump efficiency and power draw, information that can be displayed to the user/operator can further include measured or calculated values as described herein. Information anticipated to be of value to the user is shown in the communication/display step 164 of FIG. 3.

The determination of actual pump efficiency, Pump_{eff(a)} according to this exemplary embodiment is further depicted in accordance with FIG. 3 in regard to the pump 120 and pumping facility 100 previously depicted in FIG. 2, for illustrative purposes.

The first step of the process logic for this exemplary system depicted in FIG. 3 is to monitor the various pump related parameters from the various devices 136, 138, 142, 146 and 148, more specifically power kW(a), flow (Q), pump speed (N), suction and discharge pressure, on a periodic or continual basis as the inputs 155 to the system, along with other required and optional user inputs as depicted in 155 of FIG. 3. These user inputs include values for specific gravity of the fluid being pumped (e.g., water=1.0), and the published pump motor efficiency and published pump efficiency that are manually stored in the controller 152 or microprocessor of the SCADA system 180. Per step 155, head (H) is calculated as the difference between the readings provided by the pressure measuring devices 146, 148. Per step 157, monitored values for each of the above monitoring devices 136, 138, 142, 146, 148 are collected on a periodic basis by the processing system, and more specifically the controller 152. Per step 160, the collected values are interpreted at the controller 152 prior to transmission to the microprocessor of the SCADA system 180 prior to calculation of actual pump efficiency or the values can be interpreted at the SCADA system 180.

Actual pump efficiency can then be calculated, per step 158, using the relation set forth at (8),

$${Pump}_{eff ( a )} = \frac{Q \times H \times SpGr}{c \times {kW}_{( a )} \times {Motor}_{eff}}$$

in which the measured values for flow (Q), kW₍ₐ₎ and H (as converted to an Input 155) can be added along with the stored values for SpGr, Motor_{eff}, and c the unit conversion factor. This calculated value can then be compared, as described previously in regard to the published pump efficiency value or alternatively to a predetermined set point, which is stored by the SCADA system 180 per step 160. Alert and displays can then be provided in the manner discussed below.

The values as calculated, step 158, FIG. 3, and verified step 160, FIG. 3, by the interpretation component of the herein described system in SCADA system 180 are displayed per step 164. In one example, the SCADA system 180 is programmed to transmit various alarms/alerts depending on the results per steps 168, 176. For example, an alarm function can be automatically triggered if the value of a specific parameter (i.e., pump_{eff} or kW₍ₐ₎) has reached or exceeded the predetermined set point. A further indication is provided in terms of action that the at least one pump may require immediate or imminent attention (e.g., replacement) based on the predetermined set point. Various other action functions step 172, FIG. 3, can be generated in response to calculated values in connection with performance. For example and in multi-pump systems, the action generated by the herein-described system could include a proposed resequencing of the pumps used for purposes of optimization of various pump running sequences. For example and if the calculated actual pump efficiency drops below a first predetermined set point, then in addition to an alarm/alert, a maintenance alert is generated automatically as well as a cost estimate of the inefficiency. If the calculated efficiency drops below a second lower predetermined set point, the pump 120 is automatically taken off line and a back-up or lag pump (not shown) is introduced.

As noted, alarms and/or alerts, step 176, FIG. 3, can also be generated automatically by the herein described system based on predetermined thresholds. For example, an alarm can be generated if the calculated actual pump efficiency is below a predetermined set point or if the pump efficiency is above a first specific set point. Alternatively and/or in conjunction, an alarm is also triggered if certain predetermined boundary conditions are exceeded for any parameter as measured by the monitoring devices 136, 138, 142, 146 and 148. The alarm or alert that is automatically generated by the herein described system can include a visual and/or audible indicator that is provided to the user/operator either using the display of the SCADA system 180 or via other means, such as alarm lights, speakers, and the like provided in the pumping facility.

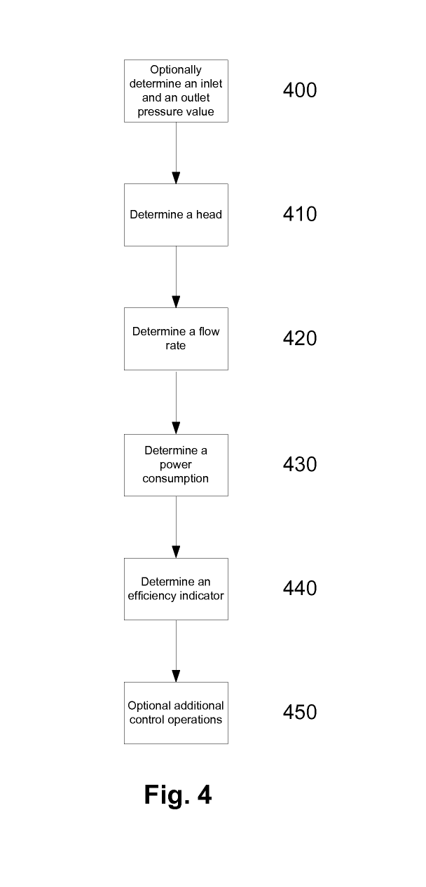

A further example of a method for determining an efficiency indicator indicative of a pump operating efficiency of one or more pumps will now be described with reference to FIG. 4. This process is typically performed at least in part using an electronic processing device, such as a suitably programmed computer system, as will be described in more detail below.

At step 400 inlet and outlet pressure values are optionally determined for the one or more pumps. The inlet and outlet pressure values may be determined in any one of a number of manners, such as by receiving signals from one or more sensors, for example the pressure measuring devices described above, or alternatively by calculating the inlet and outlet pressure values. Alternatively, the inlet and outlet pressure values may be predetermined from other equipment and made available to the electronic processing device, such as by having the processing device access the inlet and outlet pressure values from a store, such as a memory, receive signals indicative of the inlet and outlet pressure values from remote monitoring equipment, or the like.

At step 410 a head of the pumps is determined. In one example, the head is determined using a difference between the inlet and outlet pressure values, and accordingly may be calculated from the determined inlet and outlet pressure values. However this is not essential and in another example the head is calculated, accessed, received, or the like, such as described above.

At step 420 a flow rate of the pumps is determined in any suitable manner, for example using signals measured or monitored by one or more flow measuring devices, as discussed above. Alternatively the flow rate may be calculated, accessed or received from remote processing devices, for example depending on the preferred implementation.

A power consumption of the pumps is determined at step 430, and this may be achieved in any one of a number of manners. For example, the power consumption may be determined, at least in part using signals received from one or more sensors, such as a power meter. However, this is not essential, and the power consumption may be calculated, accessed, received, or otherwise determined using any suitable technique.

At step 440 the head, the flow rate, the power consumption are used to determine an efficiency indicator indicative of the pump operating efficiency of the pumps. In one example, the efficiency indicator is determined to be proportional to the flow rate of the pump and the head, and inversely proportional to the power consumption. It will be appreciated that a range of different calculations could be used in order to determine the efficiency indicator, but that in one specific example this is determined using the equations outlined above.

Following this at step 450, additional control operations may be performed. For example, the energy efficiency indicator can be displayed to a user, for example as part of an operating parameter display. Additionally, or alternatively, the energy efficiency indicator could be compared to a threshold representing a minimum desired operating efficiency of the pump. In this example, the electronic processing device can be adapted to generate an alert, such as an audible or visual indication, in the event that the efficiency falls below the threshold.

In a further example, the electronic processing device may be adapted to take action depending on the determined energy efficiency indicator. For example, in the event that the energy efficiency falls below a threshold, this could be indicative of the pump operating incorrectly, and accordingly the electronic processing device could be adapted to deactivate the pump, or take other action, such as switching pumping operations to a back-up pump or the like.

Optionally, the method may include further steps of determining a specific gravity of a fluid pumped by the pumps and/or determining a pump motor efficiency of the pumps. This may be achieved in any suitable manner, for example, the specific gravity and/or pump motor efficiency may be input by a user, for example using appropriate input commands, or may alternatively be provided by a remote processing system, accessed from a store, such as memory, calculated, or the like.

In the event that the specific gravity is used, the efficiency indicator may be determined using the specific gravity and the pump motor efficiency. Alternatively however the only the pump motor efficiency is used. In one preferred example, the efficiency indicator may be determined using any one of the equations (8) and/or (17) which are described above.

The method may be performed manually, but typically requires advanced computation and therefore typically requires the use of a monitoring device or other electronic processing device, such as a processing system. Additionally, the order of the abovementioned steps of the method, and in particular steps 400 to 430, are provided for illustrative purposes only and in practice may be performed in any particular order.

Optionally, one or more sensors for sensing characteristics of the one or more pumps may be coupled to the processing system, such as described above. In this respect, the characteristics may include any one or more of an inlet pressure, an outlet pressure, flow, power, specific gravity, or the like, all of which can be determined using sensors known to those skilled in the art.

Accordingly, the processing system is adapted to monitor signals from the one or more sensors and, generate at least in part using the signals any one or more of the inlet pressure value, outlet pressure value, the head, the flow rate, and the power consumption for one or more pumps. However, this is not essential, and the head, the flow rate and the power consumption may be determined in any other suitable manner, such as described above.

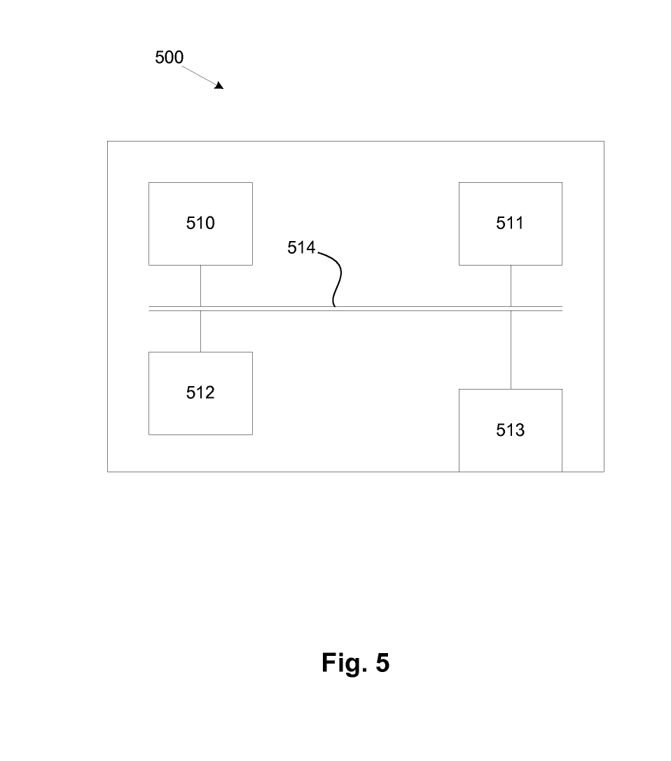

The processing system is adapted to determine an efficiency indicator indicative of a pump operating efficiency of one or more pumps, and optionally either display the efficiency indicator or alternatively transfer the efficiency indicator or data derived therefrom to a separate remote device for additional processing, analysis or display, or take action such as halting pumping operations or the like. Accordingly, the processing system can include any suitable form of electronic processing system or device that is capable of receiving signals from the sensors and calculating a pumping efficiency. An example processing system will now be described with reference to FIG. 5.

In this example, the processing system 500 includes a processor 510, a memory 511, an input/output (I/O) device 512, such as a keyboard and display, and an external interface 513 coupled together via a bus 514. It will be appreciated that the I/O device may further include an input, such as a keyboard, keypad, touch screen, button, switch, or the like which thereby allowing a user to input data.

The external interface 513 is used for coupling the processing system 500 to peripheral devices, such as an output 520, and optionally the one or more sensors, as well as to devices, such as communications networks, databases, other storage devices, or the like. Although a single external interface is shown, this is for the purpose of example only, and in practice multiple interfaces using various methods (e.g. Ethernet, serial, USB, wireless (such as Bluetooth®, Zigbee®, radio frequency networks, mobile networks or the like) may be provided. It will also be appreciated that additional hardware components, may be incorporated into the processing system 500, depending on the particular implementation.

It will further be appreciated that the electronic processing device 500 may include any suitable power supply (not shown), for example, a battery, a solar panel, or the like, however this is not essential, and alternatively, the electronic processing device 500 may be adapted to connect to mains power, an electricity grid, or the like.

In use, the processor 510 executes instructions in the form of applications software stored in the memory 511 in order to determine an efficiency indicator indicative of a pump operating efficiency of one or more pumps. Accordingly, for the purposes of the following description, it will be appreciated that actions performed by the processing system 500 are typically performed by the processor 510 under control of instructions stored in the memory 511, and this will not therefore be described in further detail below.

Accordingly, it will be appreciated that the processing system 510 may be formed from any suitably programmed processing system, such as a suitably programmed PC, Internet terminal, lap-top, hand-held PC, tablet PC, slate PC, iPad™, mobile phone, smart phone, PDA (Personal Data Assistant), or other communications device. Accordingly, the processor 510 can be any form of electronic processing device such as a microprocessor, microchip processor, logic gate configuration, firmware optionally associated with implementing logic such as an FPGA (Field Programmable Gate Array), a controller, a PLC, or any other electronic device, system or arrangement capable of determining the efficiency indicator. Additionally, whilst a single processing system is shown, it will be appreciated that the functionality could be distributed between one or more processing systems, for example in a networked or cloud based environment. Alternatively, the functionality of the processing system could be implemented using one or more controllers and a SCADA system, as described above.

It will be appreciated that the processing system 500 may further include an output for presenting the indicator to the user. In this regard, the output may include any suitable mechanism, including a light emitting diode (LED), sound emitting member such as a speaker or the like, a digital display such as a monitor or the like, an electronic signal emitting member such as a USB or Ethernet port, wireless transmitter, or similar. Accordingly, it will be appreciated that the output may generate one or more of a light, including a coloured light, a sound or tone, at least one alphanumeric character, a graph, a picture, a wireless electronic signal, a wired electronic signal, or the like.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers.

Persons skilled in the art will appreciate that numerous variations and modifications will become apparent. All such variations and modifications which become apparent to persons skilled in the art, should be considered to fall within the spirit and scope that the invention broadly appearing before described. Thus, for example, it will be appreciated that features from different examples above may be used interchangeably where appropriate.

### PARTS LIST FOR FIGS. 1-3

10 facility
20 pump
24 suction line
26 power line
28 discharge line
30 flow measuring device
32 gauge
100 facility
120 pump
124 suction line
128 discharge line
133 electrical power line, pump
136 power meter
138 flow measuring device
142 pump motor speed measuring device
146 pressure measuring device
148 pressure measuring device
152 controller
155 measured parameters
157 transmittance step
158 calculation step
160 interpretation step
164 communication/display step
168 alarm step
172 action step
176 alarm/options step
180 SCADA system

1. A method for determining efficiency of at least one pump configured in a pumping facility, said method including the steps of:
measuring various operating parameters of said at least one pump;
transmitting the measured operating parameters to a processing system; and
calculating the actual efficiency of said at least one pump based on the measured operating parameters.

2. A method according to claim 1, wherein said method further includes the step of comparing the calculated efficiency of said pump to an expected efficiency of said pump under the same operating conditions and providing an alert if the compared actual efficiency deviates from the expected efficiency by a predetermined amount.

3. A method according to claim 1, including the step of disposing a plurality of sensors for measuring the power usage and flow characteristics of said at least one pump, wherein said sensors include means for transmitting collected signals to said processing system.

4. A method according to claim 3, including the step of disposing a plurality of sensors for measuring the pump speed of said at least one pump, wherein said sensors includes means for transmitting collected signals to said processing system.

5. A method according to claim 3, wherein said plurality of sensors are configured to periodically or continually measure and transmit said operating parameters.

6. A method according to claim 3, wherein said processing system includes at least one controller that receives the readings from said monitoring devices, said method including the step of transmitting said values to said at least one controller for calculating said efficiency.

7. A method according to claim 3, wherein said processing system includes at least one controller that receives the readings from said monitoring devices, said method including the step of transmitting said values from said at least one controller to the facility operating system for calculating said efficiency.

8. A method according to claim 1, including the step of displaying at least one measured or calculated value related to said at least one pump.

9. A method according to claim 6, including the additional step of interpreting the measured readings of said sensors and the calculated values prior to said displaying step.

10. A method according to claim 9, wherein said interpreting step further includes the step of determining whether potential errors exist in at least one of the collected readings of said sensors and the calculated values.

11. A method according to claim 10, including the additional step of indicating the potential cause of said potential errors to a user or operator.

12. A method according to claim 1, wherein said pumping system is a multi-pump system, said method including the additional steps of determining a change in efficiency in at least one of the pumps and indicating a revised sequence for use of said pumps based on said change.

13. A method according to claim 1, including the additional steps of determining the actual pump efficiency, identifying the expected pump efficiency and calculating the differences between the actual and expected pump efficiencies.

14. A method according to claim 13, wherein said actual pump efficiency is determined using the relation
$${Pump}_{eff ( a )} = \frac{Q \times H \times SpGr}{c \times {kW}_{( a )} \times {Motor}_{eff}}$$
in which Q represents flow rate, H (head) represents the pressure differential between the discharge and suction sides of said at least one pump, SpGr represents the specific gravity of the incompressible fluid flowing through said pump, kW₍e₎ represents the power used by the pump, Motor_{eff} represents a published value of motor efficiency and c represents a unit conversion factor stored by said system

15. A method according to claim 13, including the steps of storing application specific and manufacturer specific data in the memory of the controller for said calculating step in conjunction with the collected pump-related data.

16. A system for measuring efficiency of said at least one pump in a pumping facility, said system including:
a plurality of sensors disposed in relation to said at least one pump to measure characteristics of said at least one pump; and
at least one controller configured to periodically receive inputs from said sensors and to calculate actual performance of said at least one pump based on said measured characteristics using the hydraulic method and in which the actual performance is compared to at least one stored threshold value relating to said at least one pump.

17. A system according to claim 16, including means for displaying at least one measured or calculated value relating to said at least one pump.

18. A system according to claim 17, wherein the inputs from said sensors and the resulting calculated values are validated prior to displaying same.

19. A system according to claim 16, wherein an alert is triggered if the performance of the at least one pump deviates from said expected performance by a predetermined amount.

20. A system according to claim 19, wherein said controller is configured to store published performance curves of said at least one pump.

21. A system according to claim 19, wherein the possible cause of deviation from the expected performance is presented to the user.

22. A system according to claim 16, wherein said controller is wirelessly connected to said sensors, each of said sensors transmitting pump-related data to said controller over the wireless connection.

23. A system according to claim 16, wherein said plurality of sensors include a flow measuring device, a power usage measuring device and at least one pressure measuring device.

24. A system according to claim 23, wherein said plurality of sensors include a pump speed measuring device.

25. A processing system for determining operating efficiency of at least one pump in a pumping facility, said system including:
at least one controller that collects characteristics of said at least one pump and having processing logic that calculates performance of said at least one pump based on said collected characteristics, said calculated performance being compared to at least one stored threshold.

26. A processing system according to claim 25, wherein said measured characteristics include flow rate, power consumption, suction and discharge pressures and pump motor speed.

27. A processing system according to claim 26, wherein real-time efficiency of said at least one pump is determined by the relation
$${Pump}_{eff ( a )} = \frac{Q \times H \times SpGr}{c \times {kW}_{( a )} \times {Motor}_{eff}}$$
in which Q represents flow rate, H (head) represents the pressure differential between the discharge and suction sides of said at least one pump, SpGr represents the specific gravity of the incompressible fluid flowing through said pump, kW(a) represents the power used by the pump, Motor_{eff} represents, a published value of motor efficiency and c represents a unit conversion factor stored by said processing system.

28. A processing system according to claim 25, wherein characteristics are collected at periodic intervals, said at least one controller including a programmable logic controller that is connected to the pumping facility's Supervisory Control and Data Acquisition (SCADA) system.

29. A processing system according to claim 25, including a plurality of sensors for measuring said pump-related characteristics in real time, said sensors having means for transmitting collected values to said at least one controller.

30. A method for determining an efficiency indicator indicative of a pump operating efficiency of at least one pump, the method including, in a electronic processing device:
a) determining a head of the at least one pump;
b) determining a flow rate of the at least one pump;
c) determining a power consumption of the at least one pump; and,
d) determining an efficiency indicator indicative of the pump operating efficiency of the at least one pump using the head, the flow rate, and the power consumption.

31. A method according to claim 30, the method including, in the electronic processing device:
a) determining an inlet pressure value of the at least one pump;
b) determining an outlet pressure value of the at least one pump; and,
c) determining the head using the inlet pressure value and the outlet pressure value.

32. A method according to claim 30, the method including, in the electronic processing device:
a) determining a specific gravity of a fluid pumped by the at least one pump; and,
b) determining the efficiency indicator using the specific gravity.

33. A method according to claim 30, the method including, in the electronic processing device:
a) determining a pump motor efficiency of the at least one pump; and,
b) determining the efficiency indicator using the pump motor efficiency.

34. An apparatus for determining an efficiency indicator indicative of a pump operating efficiency of at least one pump, the apparatus including a electronic processing device for:
a) determining a head of the at least one pump;
b) determining a flow rate of the at least one pump;
c) determining a power consumption of the at least one pump; and,
d) determining an efficiency indictor indicative of the pump operating efficiency of the at least one pump using the head, the flow rate, and the power consumption.

35. An apparatus according to claim 34, the electronic processing device for:
a) determining an inlet pressure value of the at least one pump;
b) determining an outlet pressure value of the at least one pump; and,
c) determining the head using the inlet pressure value and the outlet pressure value.

36. An apparatus according to claim 34, the apparatus including at least one sensor for sensing characteristics of the at least one pump, wherein the characteristics include at least one of:
a) an inlet pressure;
b) an outlet pressure;
c) flow; and,
d) power.

37. An apparatus according to claim 36, wherein the electronic processing device is adapted to monitor signals from the at least one sensor and, generate at least in part using the signals, any one or more of:
a) the inlet pressure value of the at least one pump;
b) the outlet pressure value of the at least one pump;
c) the head of the at least one pump;
d) the flow rate of the at least one pump; and,
e) the power consumption of the at least one pump.
